(19) United States
(12) Patent Application Publication
(10) Pub. No.: US 2023/0003449 A1
(43) Pub. Date: Jan. 5, 2023

(54) KITCHEN WASTE TREATMENT SYSTEM AND METHOD THEREOF

(71) Applicant: NAGUAL ENVIRONMENTAL PROTECTION TECHCHNOLOGY (SHENZHEN) CO, LTD., Shenzhen (CN)

(72) Inventors: Yumo PEI, Shenzhen (CN); Na PAN, Shenzhen (CN); Yong ZHENG, Shenzhen (CN)

(73) Assignee: NAGUAL ENVIRONMENTAL PROTECTION TECHNOLOGY (SHENZHEN) CO., LTD, Shenzhen (CN)

(21) Appl. No.: 17/443,680

(22) Filed: Jul. 27, 2021

(30) Foreign Application Priority Data
Jul. 5, 2021 (CN) 202110759242.9

(51) Int. Cl. F26B 25/00; B09B 3/00; C05F 9/02; C05F 9/04; B02C 23/00; G05B 15/02

(52) U.S. Cl. CPC F26B 25/009; B09B 3/0083; C05F 9/02; C05F 9/04; B02C 23/00; G05B 15/02; B02C 18/0092

(57) ABSTRACT

Disclosed are a kitchen waste treatment system and a method thereof. The kitchen waste treatment system includes a control module, a drying module, an air extraction module, a grinding module and a temperature sensor all connected with the control module. The control module is for sending a first control signal, a second control signal and a third control signal according to a current working process in a determination that it is turned on normally. The drying module is for drying kitchen waste. The air extraction module is for extracting air from the kitchen waste. The grinding module is for grinding the kitchen waste. The temperature sensor is for detecting a temperature of the drying module. The control module is further for sending a stop command to the drying module in a determination that the temperature is higher than a preset temperature threshold.

### CROSS REFERENCE TO RELATED APPLICATIONS

The present application claims the benefits of Chinese Patent Application No. 202110759242.9 entitled “KITCHEN WASTE TREATMENT SYSTEM AND METHOD THEREOF”, which was filed on Jul. 5, 2021, and the entire disclosure of which is hereby incorporated by reference, in its entirety, for all that it teaches and for all purposes.

### TECHNICAL FIELD

The present application is related to the field of garbage treatment, in particular to a kitchen waste treatment system and a method thereof.

### BACKGROUND

At present, a kitchen waste treatment system adopts processes of drying, submerging and cooling to treat the kitchen waste. The treated kitchen waste is converted into organic fertilizer. However, the existing kitchen waste treatment system only considers the protection of electric furnace filament from burning due to high temperature, and does not consider the problem that kitchen waste may not be recycled because of carbonization at high temperature.

The above content is only used to assist in understanding the technical proposal of the present application, and is not intended to acknowledge that the above content is the prior art.

### SUMMARY

The main purpose of the present application is to provide a kitchen waste treatment system and a method thereof, aiming at solving a technical problem that the kitchen waste cannot be recovered because of carbonization due to overheating by the drying temperature in the related arts.

In order to achieve the above purpose, the present application provides a kitchen waste treatment system, in particular the kitchen waste treatment system includes:

a control module, a drying module, an air extraction module and a grinding module connected with the control module and a temperature sensor arranged in the drying module and connected with the control module; in particular,

the control module is configured for sending a first control signal, a second control signal and a third control signal according to a current working process, in a determination that the kitchen waste treatment system is turned on normally;

the drying module is configured for drying kitchen waste upon receiving the first control signal;

the air extraction module is configured for extracting air from the kitchen waste upon receiving the second control signal;

the grinding module is configured for grinding the kitchen waste upon receiving the third control signal;

the temperature sensor is configured for detecting a temperature of the drying module and transmitting a temperature signal to the control module; and

the control module is further configured for sending a stop command to the drying module in a determination that a temperature indicated by the temperature signal is higher than a preset temperature threshold, to make the drying module suspend working.

Optionally, the kitchen waste treatment system further includes a start button and a position detection device connected with the control module; in particular, the start button is configured for being pressed and outputting a start signal to the control module, to start the control module;

the position detection device is configured for transmitting a position signal to the control module in a determination that the control module is turned on;

the control module is further configured for determining whether a system is normally turned on according to the position signal.

Optionally, the control module is further configured for determining the current working process according to a preset time, in particular, the current working process includes:

a drying stage, a grinding stage and a cooling stage;

the position detection device is configured for transmitting a position signal to the control module in a determination that the control module is turned on;

the control module is further configured for determining whether a system is normally turned on according to the position signal.

Optionally, the kitchen waste treatment system further includes a process indicator connected with the control module;

the process indicator is configured for receiving the display instructions and displaying the current working process and a fault alarm according to the display instructions.

Optionally, the drying module comprises an optocoupler, an electric furnace filament, a temperature-controlled switch and is connected to an external power supply for supplying power to the drying module; a control terminal of the optocoupler is connected with the control module and a power supply, a controlled terminal of the optocoupler is connected in series between an anode of the external power supply and a first terminal of the electric furnace filament, and the temperature-controlled switch is connected in series between a cathode of the external power supply and a second terminal of the electric furnace filament;

the optocoupler is configured for avoiding interference between the control module and the drying module, conducting and controlling the electric furnace filament to start heating according to the first control signal;

the temperature-controlled switch is configured for disconnecting in a determination that a temperature of the electric furnace filament exceeds a safe range to avoid burning of the electric furnace filament.

The external power supply is configured for supplying power to the drying module.

Optionally, the control module includes a microprocessor and a crystal oscillator connected with each other, the microprocessor internally includes an analog-digital input terminal and a level output terminal; the analog-digital input terminal is connected with the temperature sensor, and the level output terminal is connected with the control terminal of the optocoupler,

the crystal oscillator is configured for timing, thereby the current working process is determined by the control module according to a working time.

In addition, to realize the above purpose, the present application further provides a kitchen waste treatment method, in particular, the kitchen waste treatment method is applied to the kitchen waste treatment system mentioned above, in particular the kitchen waste system includes the control module, the drying module connected with the control module, the air extraction module, the grinding module and the temperature sensor placed in the drying module, in particular the method includes:

sending the first control signal, the second control signal and the third control signal, by the control module, according to the current working process, in a determination that the control module is normally turned on;

drying the kitchen waste by the drying module upon receiving the first control signal;

extracting the air from the kitchen waste by the air extraction module to upon receiving the second control signal;

grinding the kitchen waste by the grinding module upon receiving the third control signal;

detecting, by the temperature sensor, the temperature of the drying module and transmitting, by the temperature sensor, the temperature signal to the control module; and

sending, by the control module, the stop command, to the drying module to make the drying module stop working, in a determination that the temperature indicated by the temperature signal is higher than the preset temperature threshold.

Optionally, the kitchen waste treatment system further comprises a start button and a position detection device connected with the control module;

before the step of sending the first control signal, the second control signal and the third control signal by the control module, according to the current working process, in a determination that the control module is normally turned on, the kitchen waste treatment method further includes:

outputting a start signal to the control module to enable the control module to start when the start button is pressed;

transmitting, by the position detection device, a position signal to the control module in determination that the control module is turned on; and

determining, by the control module, whether a system is normally turned on according to the position signal.

Optionally, the step of sending the first control signal, the second control signal and the third control signal by the control module, according to the current working process in a determination that the control module is normally turned on includes:

determining, by the control module, the current working process, according to a working time, in a determination that the control module is normally turned on;

sending, by the control module the first control signal, the second control signal and the third control signal continuously, in a determination that the current working process enters at a drying stage;

sending, by the control module, the first control signal, the second control signal and the third control signal continuously, in a determination that the current working process enters at a grinding stage; and

stopping sending, by the control module, the first control signal and continuously sending, by the control module, the second control signal and the third control signal continuously, in a determination that the current working process enters at a cooling stage.

Optionally, determining, by the control module, the current working process according to a working time, in a determination that the control module is normally turned on includes:

determining, by the control module, that the current working process enters at the drying stage, in determination that the control module is normally turned on;

determining, by the control module, that the current working process enters at the grinding stage, after a first preset time; and

determining, by the control module, that the current working process enters at the cooling stage, after a second preset time.

The present application provides a kitchen waste treatment system, in particular, the kitchen waste treatment system includes a control module, a drying module connected with the control module, an air extraction module, a grinding module and a temperature sensor arranged in the drying module; in particular, the control module is configured for sending a first control signal, a second control signal and a third control signal according to the current working process, in determination that the kitchen waste treatment is turned on normally. The drying module is configured for working upon receiving the first control signal to dry the kitchen waste. The air extraction module is configured for working upon receiving the second control signal and extracting air from the kitchen waste. The grinding module is configured for working upon receiving the third control signal to grind the kitchen waste. A temperature sensor is configured for detecting a temperature of the drying module and transmitting the temperature signal to the control module. The control module is further configured for sending a stop command to the drying module in determination that the temperature signal is higher than a preset temperature threshold, so as to make the drying module suspend working. By adding the temperature signal, the drying temperature of a heating plate is reduced to prevent the kitchen waste from being carbonized due to overheating and failed to be recovered.

### BRIEF DESCRIPTION OF THE DRAWINGS

In order to explain more clearly the embodiments of the present application or the technical solution in the related arts, the following will give a brief description of the drawings required in the description of embodiments or related arts. It is apparent that the following drawings in the description are only some embodiments of the application and to those of ordinary skill in the art, on a premise of not paying creative labor, other drawings can be obtained according to the structures shown in these drawings.

FIG. 1 is a schematic block diagram of functional modules of a first embodiment of a kitchen waste treatment system of the present application.

FIG. 2 is a schematic block diagram of functional modules of a second embodiment of the kitchen waste treatment system of the present application.

FIG. 3 is a schematic diagram of circuit structure of a drying module and a control module of an embodiment of the kitchen waste treatment system of the present application.

FIG. 4 is a flow chart of a first embodiment of a kitchen waste treatment method of the present application.

FIG. 5 is a flow chart of a second embodiment of the kitchen waste treatment method of the present application.

The realization of the purposes, functional features and advantages of the present application will be further described with reference to the accompanying drawings in combination with the embodiments.

### DETAILED DESCRIPTION OF THE EMBODIMENTS

It should be understood that the specific embodiments described here are intended to explain the application only and are not intended to limit it. The technical schemes of the embodiments of the present application will now be clearly and completely described in conjunction with the accompanying drawings of the embodiments of the present application, and it will be apparent that the described embodiments are only some of the embodiments of the present application, not all of them. Based on the embodiments of the present application, all other embodiments obtained by those of ordinary skill in the art without creative work are within the scope of the present application. It should be noted that all directivity indications (such as up, down, left, right, front, back, etc.) in the embodiment of the present application are only used to explain relative positional relationship, movement situation, etc. among components in a specific posture (as shown in the attached drawings), and if the specific posture changes, the directivity indications will change accordingly.

In addition, the descriptions in the present application relating to “first”, “second” and the like are for descriptive purposes only and cannot be construed as indicating or implying their relative importance or implying the number of technical features indicated. Therefore, a feature defined as “first” and “second” may explicitly or implicitly include at least one such feature.

In addition, the technical solutions among the various embodiments may be combined with each other. However, the combination must be on a basis that a person of ordinary skill in the art can realize it. When the combination of technical solutions is contradictory or impossible to be realized, it should be considered that the combination of technical solutions does not exist and is not within the scope of protection claimed by the present application.

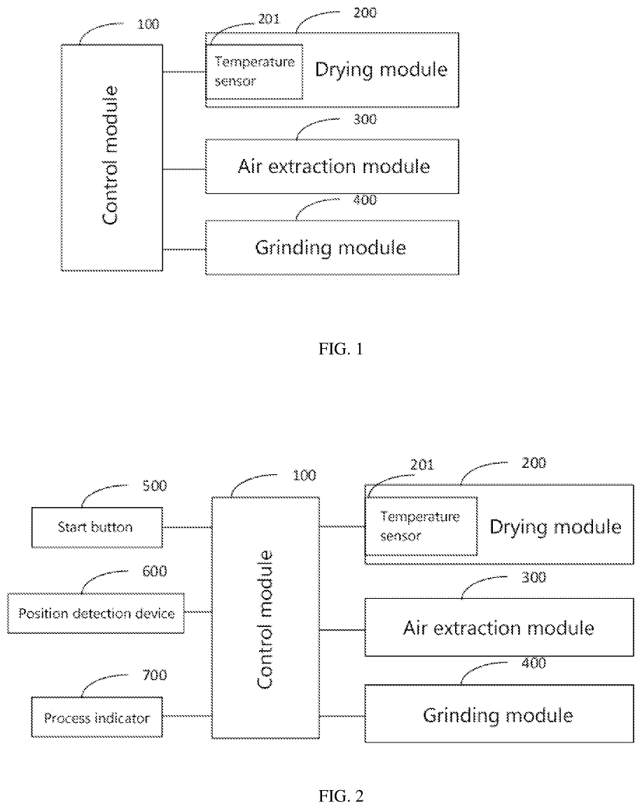

According to FIG. 1, FIG. 1 is a schematic block diagram of functional modules of an embodiment of the kitchen waste treatment system of the present application. The kitchen waste treatment system includes a control module 100, a drying module 200 connected with the control module 100, an air extraction module 300, a grinding module 400 and a temperature sensor 201 arranged in the drying module 200.

The control module 100 is configured for sending a first control signal, a second control signal and a third control signal according to a current working process when the control module 100 is normally turned on.

It should be noted that the control module 100 at least includes a single chip microcomputer with an internal timer and an analog-to-digital converter, such as a STM8 series single chip microcomputer. The internal timer is configured to time according to actual operation needs, and the analog-to-digital converter is configured to receive an analog signal transmitted by an externally connected detection device and convert the analog signal into a digital signal, so that further control instructions may be made through determining and analyzing the digital signal by the single chip microcomputer.

It is understood that the control module 100 should further include a debugging unit, such as a CH340, for communicating with a computer to realize burning and debugging of programs. In the embodiment, it can be based on actual situation, to carry out a chip selection, and this embodiment does not limit this.

The drying module 200 is configured to dry the kitchen waste, upon receiving the first control signal.

It can be understood that the first control signal is a voltage signal transmitted by a pin of the single chip microcomputer. Components in the drying module 200 are activated to operate and raise a temperature to dry the kitchen waste, in a determination that the voltage signal is received by the drying module 200. Kitchen waste is usually wet, which is not conducive to be broken and other operations, so it needs to be dried during treatment.

The air extraction module 300 is configured for working to extract air from the kitchen waste in a determination that the second control signal is received.

In this embodiment, the air extraction module 300 includes at least a boosting circuit and a centrifugal fan. The boosting circuit is configured for boosting the voltage signal output by the single chip microcomputer, so that a voltage on a loop is enough to drive the centrifugal fan to rotate and extract the air generated by heating in the device. At the same time, the air extraction module 300 should further include some activated carbon for absorbing impurities and peculiar smell during the air extraction process, so as to avoid air pollution and discomfort to operators. In a specific implementation, more related components may be added according to actual needs, which is not limited by this embodiment.

The grinding module 400 is configured to grind the kitchen waste upon receiving the third control signal.

In this embodiment, the grinding module 400 includes at least a driver, a gear reduction motor, a gear set and a stirring blade connected in sequence. The driver may be a L298N for driving motors, which is configured to drive the gear reduction motor to operate according to the third control signal, so as to drive the gear set to rotate to cause the stirring blade to rotate and grind the dried kitchen waste.

The temperature sensor 201 is configured for detecting a temperature of the drying module 200 and transmitting a temperature signal to the control module 100.

In this embodiment, the temperature sensor 201 is configured using a thermocouple. The thermocouple is a commonly used temperature measuring element in temperature measuring instruments, which directly measures temperature and converts a temperature signal into a thermoelectromotive force signal. Shapes of various thermocouples are often very different due to requirements. However, their basic structures are roughly the same. They are usually composed of hot electrodes, insulating sleeves protective tubes and junction boxes. Because they are in direct contact with measured objects, the temperature measurement is not affected by intermediate medium.

It should be noted that in the process of high-temperature drying and grinding, the temperature in the device may be too high. When the temperature in the device is higher than 120 degree Celsius, the kitchen waste is carbonized, and the carbonized kitchen waste cannot be converted into organic fertilizer, resulting in a decrease in recycling rate and waste of resources.

The control module 100 is further configured for sending a stop command to the drying module 200 in a determination that the temperature indicated by the temperature signal is higher than a preset temperature threshold, so as to suspend an operation of the drying module 200.

In this embodiment, the preset temperature threshold is 120 degree Celsius.

The embodiment provides a kitchen waste treatment system, which includes the control module 100, and the drying module 200, the air extraction module 300, the grinding module 400 and the temperature sensor 201 arranged in the drying module 200 all connected with the control module 100. In particular, the control module 100 is configured for sending the first control signal, the second control signal and the third control signal according to the current working process in a determination that the kitchen waste treatment system is normally turned on. The drying module 200 is configured to dry the kitchen waste upon receiving the first control signal. The air extraction module 300 is configured to extract air from the kitchen waste upon receiving the second control signal. The grinding module 400 is configured to grind the kitchen waste upon receiving the third control signal. The temperature sensor 201 is configured for detecting a temperature of the drying module 200 and transmitting a temperature signal to the control module 100. The control module 100 is further configured for sending the stop command to the drying module 200 in a determination that the temperature signal is higher than the preset temperature threshold, so as to suspend an operation of the drying module 200. By adding a temperature feedback, a drying temperature of a heating plate is reduced to prevent the kitchen waste from being not recyclable because of carbonization due to overheating.

Further, according to FIG. 2, FIG. 2 is a functional module block diagram of a second embodiment of the kitchen waste treatment system of the present application.

The kitchen waste treatment system further includes a start button 500 and a position detection device 600 connected with the control module 100.

The start button 500 is configured for outputting a start signal to the control module 100 to start the control module 100 when the start button 500 is pressed.

It can be understood that the start button 500 can be connected to the control module 100 through an interface. When the start button 500 is pressed, a level signal may be sent to the control module 100, so that the control module 100 may start a circuit carried by the control module 100. The level signal may be determined as a high level or a low level according to a method of connecting the start button 500, and is not limited by the present embodiment.

The position detection device 600 is configured for transmitting a position signal to the control module 100 in a determination that the control module 100 is turned on.

It should be noted that the position detection device 600 is a magnetoresistive sensor. The magnetoresistive sensor is based on a working principle of magnetoresistive effect, and its core part is a special metal material, a resistance value of the metal material changes with a change of external magnetic field, and the change or state of objects can be measured by the change of external magnetic field. The magnetoresistive sensor has characteristics of high precision, high sensitivity, high resolution, good stability and reliability, non-contact measurement and wide temperature range, and can be configured for dynamic and static measurement. The magnetoresistive sensor is widely used in low magnetic field measurement, angle and position measurement.

The control module 100 is further configured for determining whether the system is normally turned on according to the position signal.

In this embodiment, the position signal is configured to provide feedback for determination that a cover of the device is closed. In a determination that the cover of the device is not in a closed state, it is determined by the control module 100 that the system is not turned on normally.

Further, according to FIG. 2, the control module 100 is further configured for determining the current working process according to a preset time, in particular, current working processes includes: a drying stage, a grinding stage and a cooling stage.

The control module 100 is further configured for generating a fault signal in a determination that the system is not normally turned on. It could be understood that the system generates a fault signal in a determination that the feedback information of the position signal is that the cover of the device is not in a closed state.

The control module 100 is further configured for generating a display instruction according to the current working process and the fault signal. It will be understood that the display instructions contain display information for controlling an associated component to display a current state of the device.

It should be noted that when the current working process is at the drying stage, the drying module 200, the air extraction module 300 and the grinding module 400 work at the same time. When the current working process is at the grinding stage, the drying module 200, the air extraction module 300 and the grinding module 400 work at the same time. When the current working process is at the cooling stage, the air extraction module 300 and the grinding module 400 work at the same time.

Further, according to FIG. 2, the kitchen waste treatment system further includes a process indicator 700 connected to the control module 100.

The process indicator 700 is configured for receiving the display instructions and displaying the current working process and a fault alarm according to the display instructions.

In the present embodiment, the process indicator 700 includes three LED lamps. When the current working process is respectively at the drying stage, the grinding stage and the cooling stage, the corresponding LED lamps are illuminated. When the cover of the device is not closed, the three LED lamps flash at the same time.

In this embodiment, the start button 500 is set to start the device, the position detection device 600 is set to detect whether the device is turned on normally. Different working processes are set for a working interval, and the corresponding working processes are displayed through the process indicator 700, ensuring safety of operation of the device and facilitating users to know a working state in time.

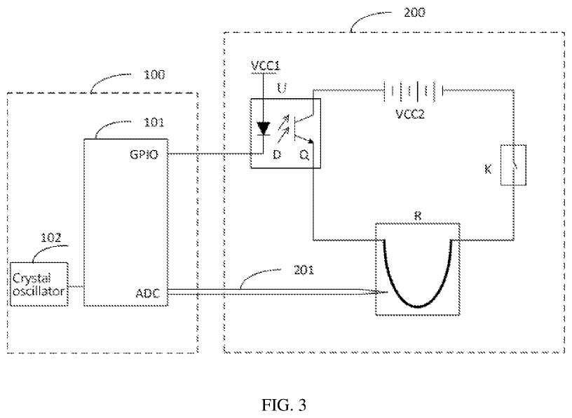

Further, according to FIG. 3, FIG. 3 is a schematic diagram of circuit structures of the drying module 200 and the control module 100 of an embodiment of the kitchen waste treatment system of the present application.

The drying module 200 comprises an optocoupler U, an electric furnace filament R, a temperature-controlled switch K and an external power supply VCC2. In particular, a control terminal of the optocoupler U is connected with the control module 100 and a power supply VCC1, a controlled terminal of the optocoupler U is connected in series between an anode of the external power supply VCC2 and a first terminal of the electric furnace filament R, and the temperature-controlled switch K is connected in series between a cathode of the external power supply VCC2 and a second terminal of the electric furnace filament R.

The Optocoupler U is configured for avoiding interference between the control module 100 and the drying module 200.

It should be noted that the optocoupler U is a component electrically isolating the control terminal from the controlled terminal through photoelectric effect, so that the controlled circuit may avoid interference.

The optocoupler U is further configured for conducting according to the first control signal to control the electric furnace filament R to start heating.

In this embodiment, the optocoupler U includes a light emitting diode D and a phototransistor Q, an anode of the light emitting diode D is connected with the power supply VCC1, a cathode of the light emitting diode D is connected with the control module 100, a collector of the phototransistor Q is connected with the anode of the external power supply VCC2, and an emitter of the phototransistor Q is connected with the first terminal of the electric furnace filament R. When the cathode of the light emitting diode D receives the first control signal sent by the control module 100, the light emitting diode D is turned on, the phototransistor Q is turned on through coupling, a potential difference is generated across both ends of the electric furnace filament R, and the electric furnace filament R starts heating.

The temperature-controlled switch K is configured to be disconnected when a temperature of the electric furnace filament R exceeds a safe range, so as to avoid burning the electric furnace filament R.

It could be understood that, according to a temperature change of the working environment, the temperature-controlled switch undergoes physical deformation inside the switch, so as to disconnect a circuit where the electric furnace filament R is located when the temperature of the electric furnace filament R exceeds the safe range and protect the circuit.

The external power supply VCC2 is configured for supplying power to the drying module 200.

It should be noted that the external power supply VCC2 is not a same power supply as the power supply VCC1 used by the single chip microcomputer.

Further, according to FIG. 3, the control module 100 includes a microprocessor 101 and a crystal oscillator 102 connected to each other. The microprocessor 101 includes an analog-digital input terminal ADC and a level output terminal GPIO. The analog-digital input terminal ADC is connected with the temperature sensor 201, and the level output terminal GPIO is connected with the control terminal of the optocoupler U.

The crystal oscillator 102 is configured for timing so that a current working process is determined by the control module 100 according to a working time.

It should be noted that the level output terminal GPIO is connected to the cathode of the light emitting diode D of the optocoupler U.

This embodiment prevents the drying module 200 from electrical interference, and at the same time prevents the electric furnace filament R from burning, improving reliability and safety of the kitchen waste treatment system.

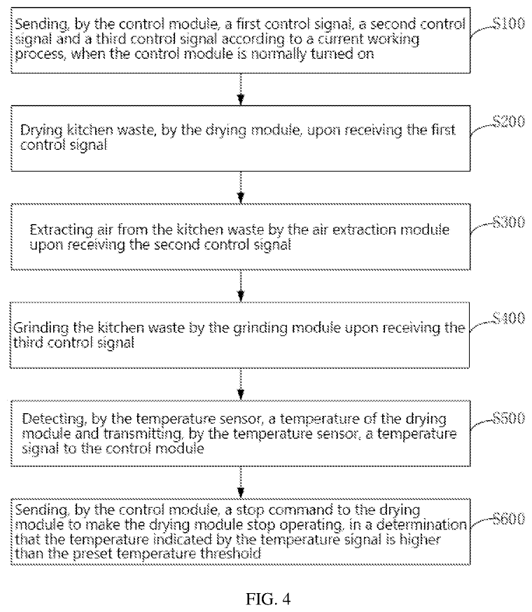

FIG. 4 is a flow chart of a first embodiment of a kitchen waste treatment method of the present application.

According to FIG. 4, the kitchen waste treatment method is applied to the kitchen waste treatment system described above, the kitchen waste system includes a control module, a drying module, an air extraction module and a grinding module all connected with the control module, and a temperature sensor placed in the drying module and connected with the control module, in particular the kitchen waste treatment method includes:

Step S100: sending, by the control module, a first control signal, a second control signal and a third control signal according to a current working process, when the control module is normally turned on. It should be noted that the control module at least includes a single chip microcomputer with an internal timer and an analog-to-digital converter, such as a STM8 series single chip microcomputer. The internal timer is configured to time according to actual operation requirements, and the analog-to-digital converter is configured to receive an analog signal transmitted by an externally connected detection device and convert the analog signal into a digital signal, so as that the digital signal is determined and analyzed through the single chip microcomputer and further control instructions are made.

It can be understood that the control module should further include a debugging unit, such as a CH340, which is configured to communicate with a computer and realize burning and debugging of a program. In a specific implementation, a chip selection can be carried out according to an actual situation, and this embodiment does not limit this.

Step S200: drying kitchen waste, by the drying module, upon receiving the first control signal.

It could be understood that, the first control signal is a voltage signal transmitted by a pin of the single chip microcomputer. In a determination that the drying module receives the voltage signal, components in the drying module may start working and raise a temperature to dry the kitchen waste. The kitchen waste is usually wet, which is not conducive to breaking and other operations, so it needs to be dried during treatment.

Step S300: extracting air from the kitchen waste by the air extraction module upon receiving the second control signal.

In this embodiment, the air extraction module at least includes a boosting circuit and a centrifugal fan. The boosting circuit is configured for boosting the voltage signal output by the single chip microcomputer, so that a voltage on a loop is enough to drive the centrifugal fan to rotate and extract the air generated by heating in the device. At the same time, the air extraction module should further include some activated carbon for absorbing impurities and peculiar smell during the air extraction process, so as to avoid air pollution and discomfort to operators. In a specific implementation, more related components may be added according to actual requirements, and this embodiment does not limit this.

Step S400: grinding the kitchen waste by the grinding module upon receiving the third control signal.

In this embodiment, the grinding module at least includes a driver, a gear reduction motor, a gear set and a stirring blade connected in sequence. The driver may be a L298N for driving motors, which is configured to drive the gear reduction motor to operate according to the third control signal, so as to drive the gear set to rotate to cause the stirring blade to rotate and grind the dried kitchen waste.

Step S500: detecting, by the temperature sensor, a temperature of the drying module and transmitting, by the temperature sensor, a temperature signal to the control module.

In this embodiment, a thermocouple is selected as the temperature sensor. The thermocouple is a commonly used temperature measuring element in temperature measuring instruments, which directly measures temperature and converts a temperature signal into a thermoelectromotive force signal. Shapes of various thermocouples are often very different due to requirements. However, their basic structures are roughly the same. They are usually composed of hot electrodes, insulating sleeves protective tubes and junction boxes. Because they are in direct contact with measured objects, the temperature measurement is not affected by intermediate medium.

It should be noted that in the process of high-temperature drying and grinding, the temperature in the device may be too high. When the temperature in the device is higher than 120 degree Celsius, the kitchen waste is carbonized, and the carbonized kitchen waste will not be converted into organic fertilizer, resulting in a decrease in recycling rate and waste of resources.

Step S600: sending, by the control module, a stop command to the drying module to make the drying module stop operating, in a determination that the temperature indicated by the temperature signal is higher than the preset temperature threshold.

In this embodiment, the preset temperature threshold is 120 degree Celsius.

The embodiment provides a kitchen waste treatment method, with a temperature feedback is, a drying temperature of a heating plate is reduced to prevent kitchen waste from being not recyclable because of carbonization due to overheating.

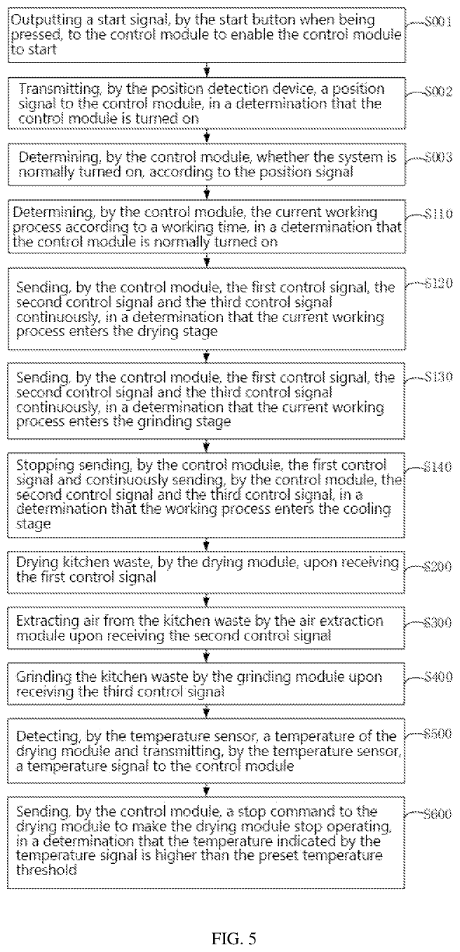

FIG. 5 is a flow chart of a second embodiment of the kitchen waste treatment method of the present application.

According to FIG. 5, the kitchen waste treatment system further includes a start button and a position detection device connected with the control module.

Before the step of sending, by the control module, a first control signal, a second control signal and a third control signal according to a current working process, when the control module is normally turned on, the method further includes:

Step S001: outputting a start signal, by the start button when being pressed, to the control module to enable the control module to start.

It can be understood that the start button can be connected to the control module through an interface. When the start button is pressed, a level signal can be output to the control module to make the control module start a circuit carried by the control module 100. The level signal can be determined as a high level or a low level according to a way of connection of the start button, which is not limited by the present embodiment.

Step S002: transmitting, by the position detection device, a position signal to the control module, in a determination that the control module is turned on.

It should be noted that the position detection device is a magnetoresistive sensor. The magnetoresistive sensor is based on a working principle of magnetoresistive effect, and its core part is a special metal material, whose resistance value changes with a change of external magnetic field, and the change or state of objects can be measured by the change of external magnetic field. The magnetoresistive sensor has characteristics of high precision, high sensitivity, high resolution, good stability and reliability, non-contact measurement and wide temperature range, and can be configured for dynamic and static measurement. The magnetoresistive sensor is widely used in low magnetic field measurement, angle and position measurement.

Step S003: determining, by the control module, whether the system is normally turned on, according to the position signal.

In this embodiment, the position signal is configured to give feedback whether the cover of the device is closed, and in a determination that the cover of the device is not in a closed state, it is determined by the control module that the system is not turned on normally.

Further, according to FIG. 4, Step S100 includes:

Step S110: determining, by the control module, the current working process according to a working time, in a determination that the control module is normally turned on.

It should be noted that in this embodiment, current working processes include a drying stage, a grinding stage and a cooling stage. The working time may be set by programming according to actual working requirements, and the present embodiment does not limit this.

Step S120: sending, by the control module, the first control signal, the second control signal and the third control signal continuously, in a determination that the current working process enters the drying stage.

It should be noted that in this embodiment, when the current working process is at the drying stage, the drying module, the air extraction module and the grinding module work at the same time.

Step S130: sending, by the control module, the first control signal, the second control signal and the third control signal continuously, in a determination that the current working process enters the grinding stage.

It should be noted that in this embodiment, in a determination that the current working process is at the grinding stage, the drying module, the air extraction module and the grinding module work at the same time.

Step S140: stopping sending, by the control module, the first control signal and continuously sending, by the control module, the second control signal and the third control signal, in a determination that the working process enters the cooling stage.

It should be noted that in this embodiment, in a determination that the current working process is at the cooling stage, the air extraction module and the grinding module work at the same time.

Further, according to FIG. 5, Step S110 includes: determining, by the control module, that the current working process enters the drying stage, in a determination that the control module is normally turned on.

In this embodiment, the drying stage is a first working process, and in a determination that information transmitted by the position detection device indicates that the cover of the device is in a closed state, the control module is normally turned on and enters the drying stage.

After a first preset time, it is determined by the control module that the current working process enters the grinding stage.

In this embodiment, the first preset time is set in the microprocessor by an operator through programming, which reflects a time required by the drying stage in a normal working interval.

After a second preset time, it is determined by the control module that the current working process enters the cooling stage.

In this embodiment, the second preset time is set in the microprocessor by the operator through programming, which reflects a time required by the grinding stage in the normal working interval.

It should be understood that a third preset time may further be set. After the third preset time, a shutdown instruction is issued by the control module to all modules, and the device is stopped working until the start button is pressed again.

By setting working modes of different working processes in a working interval, the embodiment realizes an efficient kitchen waste treatment, and simultaneously prevents a problem that the kitchen waste is difficult to be recycled due to carbonization caused by overheating.

It should be understood that the above is for illustration only and does not create any limitation to the technical proposal of the present application. In specific applications, those skilled in the art may make arrangements as needed, and the present application does not limit this.

It should be noted that the above-described workflow is only schematic and does not limit a scope of protection of the present application. In practical applications, the technical skilled in the field may select a part or all of the workflow according to actual needs to realize the purpose of the embodiment scheme, and no limitation is made here.

In addition, technical details not described in detail in this embodiment may refer to the kitchen waste treatment system provided by any embodiment of the present application, and will not be repeated here.

In addition, it should be noted that, in this article, the terms “comprise”, “include” or any variation thereof are intended to encompass non-exclusive inclusion, so that a process, method, article or system that includes a set of elements includes not only those elements but further other elements that are not explicitly listed or those are inherent to the process, method, article or system. In absence of further limitations, an element defined by a sentence “includes one . . . ” does not preclude the existence of other same elements in the process, method, article or system in which it is included.

The above serial numbers of the embodiments of the application are for description only and do not represent advantages and disadvantages of the embodiments.

Through the above description of the embodiments, it will be clear to those skilled in the art that the method of the above embodiments may be implemented by means of software plus a necessary common hardware platform, and of course further by means of hardware, but in many cases, the former is a preferred embodiment. Based on this understanding, the technical proposal of the present application, or in essence the part that contributes to the related art may be embodied in a form of a computer software product. The computer software product is stored in a storage medium (e.g. a Read Only Memory (ROM)/RAM, a magnetic disk, an optical disk) and includes instructions for causing a terminal device (which may be a handset, a computer, a server, a network a device, etc.) to perform the methods described in various embodiments of the present application.

The above are only optional embodiments of the present application, and are not therefore limiting the patent scope of the present application. Any equivalent structure or equivalent process transformation made by using the contents of the present specification and drawings, or directly or indirectly applied to other related technical fields, are similarly included in the patent protection scope of the present application.

What is claimed is:

1. A kitchen waste treatment system, comprising:
a control module, a drying module, an air extraction module and a grinding module connected with the control module and a temperature sensor arranged in the drying module and connected with the control module; wherein,
the control module is configured for sending a first control signal, a second control signal and a third control signal according to a current working process in a determination that the kitchen waste treatment system is turned on normally;
the drying module is configured for drying kitchen waste upon receiving the first control signal;
the air extraction module is configured for extracting air from the kitchen waste upon receiving the second control signal;
the grinding module is configured for grinding the kitchen waste upon receiving the third control signal;
the temperature sensor is configured for detecting a temperature of the drying module and transmitting a temperature signal to the control module; and
the control module is further configured for sending a stop command to the drying module in a determination that a temperature indicated by the temperature signal is higher than a preset temperature threshold, to make the drying module suspend working.

2. The kitchen waste treatment system according to claim 1, further comprising a start button and a position detection device connected with the control module; wherein,
the start button is configured for being pressed and outputting a start signal to the control module, to start the control module;
the position detection device is configured for transmitting a position signal to the control module in a determination that the control module is turned on; and
the control module is further configured for determining whether a system is normally turned on according to the position signal.

3. The kitchen waste treatment system according to claim 1, wherein the control module is further configured for:
determining the current working process according to a preset time, wherein current working processes comprises a drying stage, a grinding stage and a cooling stage;
generating a fault signal in a determination that a system is not normally turned on; and
generating display instructions according to the current working process and the fault signal.

4. The kitchen waste treatment system according to claim 3, further comprising a process indicator connected with the control module;
wherein the process indicator is configured for receiving the display instructions and displaying the current working process and a fault alarm according to the display instructions.

5. The kitchen waste treatment system according to claim 1, wherein, the drying module comprises an optocoupler, an electric furnace filament, a temperature-controlled switch and is connected to an external power supply for supplying power to the drying module; a control terminal of the optocoupler is connected with the control module and a power supply, a controlled terminal of the optocoupler is connected in series between an anode of the external power supply and a first terminal of the electric furnace filament, and the temperature-controlled switch is connected in series between a cathode of the external power supply and a second terminal of the electric furnace filament;
the optocoupler is configured for avoiding interference between the control module and the drying module, conducting and controlling the electric furnace filament to start heating according to the first control signal; and
the temperature-controlled switch is configured for disconnecting in a determination that a temperature of the electric furnace filament exceeds a safe range to avoid burning of the electric furnace filament.

6. The kitchen waste treatment system according to claim 5, wherein the control module comprises a microprocessor and a crystal oscillator connected with each other; the microprocessor internally comprises an analog-digital input terminal and a level output terminal; the analog-digital input terminal is connected with the temperature sensor, and the level output terminal is connected with the control terminal of the optocoupler;
the crystal oscillator is configured for timing, thereby the current working process is determined by the control module according to a working time.

7. A kitchen waste treatment method, wherein the kitchen waste treatment method is applied to the kitchen waste treatment system according to claim 1, the method comprises:
sending the first control signal, the second control signal and the third control signal, by the control module, according to the current working process, in a determination that the control module is normally turned on;
drying the kitchen waste by the drying module upon receiving the first control signal;
extracting the air from the kitchen waste by the air extraction module to upon receiving the second control signal;
grinding the kitchen waste by the grinding module upon receiving the third control signal;
detecting, by the temperature sensor, the temperature of the drying module and transmitting, by the temperature sensor, the temperature signal to the control module; and
sending, by the control module, the stop command to the drying module to make the drying module stop working, in a determination that the temperature indicated by the temperature signal is higher than the preset temperature threshold.

8. The kitchen waste treatment method according to claim 7, wherein the kitchen waste treatment system further comprises a start button and a position detection device connected with the control module;
before the step of sending the first control signal, the second control signal and the third control signal by the control module, according to the current working process, in a determination that the control module is normally turned on, the kitchen waste treatment method further comprises:
outputting a start signal to the control module to enable the control module to start when the start button is pressed;
transmitting, by the position detection device, a position signal to the control module in a determination that the control module is turned on; and
determining, by the control module, whether a system is normally turned on according to the position signal.

9. The kitchen waste treatment method according to claim 8, wherein the step of sending the first control signal, the second control signal and the third control signal by the control module, according to the current working process, in a determination that the control module is normally turned on comprises:
determining, by the control module, the current working process according to a working time, in a determination that the control module is normally turned on;
sending, by the control module the first control signal, the second control signal and the third control signal continuously, in a determination that the current working process enters a drying stage;
sending, by the control module, the first control signal, the second control signal and the third control signal continuously, in a determination that the current working process enters a grinding stage; and
stopping sending, by the control module, the first control signal and continuously sending, by the control module, the second control signal and the third control signal continuously, in a determination that the current working process enters a cooling stage.

10. The kitchen waste treatment method according to claim 9, wherein, determining, by the control module, the current working process according to a working time, in a determination that the control module is normally turned on comprises:
determining, by the control module, that the current working process enters the drying stage, in a determination that the control module is normally turned on;
determining, by the control module, that the current working process enters the grinding stage after a first preset time; and
determining, by the control module, that the current working process enters the cooling stage after a second preset time.
